(19) United States
(12) Patent Application Publication
(10) Pub. No.: US 2026/0265851 A1
(43) Pub. Date: Sep. 10, 2026

(54) ONE-STEP CARBO-NITRO-AUSTEMPERING PROCESS FOR FORMING STEEL BEARINGS

(71) Applicant: GM Global Technology Operations LLC, Detroit, MI (US)

(72) Inventors: Peng Shen, Troy, MI (US); Wenying Yang, Rochester Hills, MI (US); Jack M. Gayney, Grosse Ile, MI (US); Yi Liu, Troy, MI (US); Zhe Li, Rochester, MI (US); Gregory Melekian, Clarkston, MI (US)

(73) Assignee: GM Global Technology Operations LLC, Detroit, MI (US)

(21) Appl. No.: 19/069,718

(22) Filed: Mar. 4, 2025

(51) Int. Cl. C21D 1/74; C21D 1/20; C21D 9/40; C23C 8/32; F16C 33/34

(52) U.S. Cl. CPC C21D 1/74; C21D 1/20; C21D 9/40; C23C 8/32; F16C 33/34; F16C 2202/04; F16C 2204/60; F16C 2223/16; F16C 2240/60; F16C 2326/01

(57) ABSTRACT

A method for forming a component for a steel bearing. The method includes forming a steel-bearing component comprising a bainite-dominant material and forming in the steel-bearing component a nitrogen-strengthened surface layer, wherein the nitrogen-strengthened surface layer is formed by diffusing nitrogen with or without carbon into a surface layer of the component using a one-step carbo-nitro-austempering heat treatment cycle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

A bearing is a crucial part in various mechanical systems and is designed to reduce friction and support radial and axial loads. Bearings typically include multiple components including a series of small, hardened steel rolling elements that roll between two smooth concentric rings called races. An inner race is typically attached to a rotating shaft or wheel, while an outer race is typically attached to a housing. As the wheel or shaft rotates, the bearings roll, allowing for smooth and efficient movement with minimal resistance. This design not only enhances the performance and longevity of the machinery but also ensures precision and stability in high-speed applications. Bearings are commonly used in automotive vehicles and powertrains, industrial machinery, windmills, and various other applications where reliable and efficient rotation is essential.

The present disclosure relates generally to a one-step carbo-nitro-austempering process for forming races and rolling elements for steel bearings.

### SUMMARY

One aspect of the disclosure provides a vehicle including a steel bearing. The steel bearing includes an inner bearing race, an outer bearing race, and a plurality of rolling elements positioned between the inner bearing race and the outer bearing race to maintain a substantially fixed distance between the inner bearing race and the outer bearing race and to reduce a rotational friction between the inner bearing race and the outer bearing race as the inner bearing race and the outer bearing race rotate with respect to each other. At least one of the inner bearing race, the outer bearing race, or the rolling elements includes a bainite-dominant core and a nitrogen-strengthened surface layer. The nitrogen-strengthened surface layer is formed by diffusing nitrogen with or without carbon into a surface layer of the at least one of the inner bearing race, the outer bearing race, or the rolling elements using a one-step carbo-nitro-austempering heat treatment cycle.

Implementations of the disclosure may include one or more of the following optional features. In some implementations, the nitrogen-strengthened surface layer is formed by also diffusing carbon into the surface layer. In some examples, the one-step carbo-nitro-austempering heat treatment cycle includes austenitizing a steel-bearing component in a carbon and nitrogen rich environment at an austenitizing temperature, quenching the component to a lower bainitic transformation temperature that is above a martensitic transformation start temperature, maintaining the component at the lower bainitic transformation temperature for a pre-determined period of time, and cooling the component. The steel-bearing component may include high carbon steel or low carbon steel with or without additional alloying elements. in some implementations, the austenitizing temperature is between 800° C. and 1000° C., quenching the component comprises using a salt bath or isothermal media to quench the component, the lower bainitic transformation temperature is between 180° C. and 300° C., and the pre-determined period of time comprises a period of time between one and thirty hours.

In some examples, the nitrogen-strengthened surface layer has a thickness between 50 and 1000 microns, and a surface hardness of at least 75 HR30N. Alternatively, the nitrogen-strengthened surface layer has a thickness of at least 50 microns. In some implementations, the nitrogen-strengthened surface layer includes at least 15 percent retained austenite. In some examples, the bainite-dominant core includes at least 80 percent bainite, between 0 and 10 percent retained austenite, and between 0 and 10 percent carbides with tempered martensite remainder. In some examples, the bainite-dominant core has a hardness of at least 25 HRC.

Another aspect of the disclosure provides a method for forming a component for a steel bearing. The method includes forming a steel-bearing component comprising a bainite-dominant core and forming in the steel-bearing component a nitrogen-strengthened surface layer. The nitrogen-strengthened surface layer is formed by diffusing nitrogen with or without carbon into a surface layer of the component using a one-step carbo-nitro-austempering heat treatment cycle.

Implementations of the disclosure may include one or more of the following optional features. In some implementations, the one-step carbo-nitro-austempering heat treatment cycle includes austenitizing a steel-bearing component in a carbon and nitrogen rich environment at an austenitizing temperature, quenching the component to a lower bainitic transformation temperature that is above a martensitic transformation start temperature, maintaining the component at the lower bainitic transformation temperature for a pre-determined period of time, and cooling the component. The steel-bearing component may include high carbon steel or low carbon steel with or without additional alloying elements. in some implementations, the austenitizing temperature is between 800° C. and 1000° C., quenching the component comprises using a salt bath or isothermal media to quench the component, the lower bainitic transformation temperature is between 180° C. and 300° C., and the pre-determined period of time comprises a period of time between one and thirty hours.

Yet another aspect of the disclosure provides a component for a steel bearing. The component includes a bainite-dominant core, and a nitrogen-strengthened surface layer. The nitrogen-strengthened surface layer is formed by diffusing nitrogen with or without carbon into a surface layer of the component using a one-step carbo-nitro-austempering heat treatment cycle.

In some examples, the nitrogen-strengthened surface layer has a thickness between 50 and 1000 microns, and a surface hardness of at least 75 HR30N. Alternatively, the nitrogen-strengthened surface layer has a thickness of at least 50 microns. In some implementations, the nitrogen-strengthened surface layer includes at least 15 percent retained austenite. In some examples, the bainite-dominant core includes at least 80 percent bainite, between 0 and 10 percent retained austenite, and between 0 and 10 percent carbides with tempered martensite remainder. In some examples, the bainite-dominant core has a hardness of at least 25 HRC.

### BRIEF DESCRIPTION OF THE DRAWINGS

The drawings described herein are for illustrative purposes only of selected configurations and are not intended to limit the scope of the present disclosure.

FIG. 1 is a view of an example vehicle including a steel bearing having rolling elements and races in accordance with the principles of the present disclosure.

FIG. 2 is a partial cross-sectional perspective view of the steel bearing of FIG. 1.

FIG. 3 is cross-sectional view of an example component for a steel bearing in accordance with the principles of the present disclosure.

FIG. 4 is a flow chart of an example arrangement of operations for a method of forming a component for a steel bearing.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A bearing is a crucial part in various mechanical systems. A bearing is designed to reduce friction and support radial and axial loads. A bearing is comprised of multiple components including a series of small, hardened steel rolling elements that roll between two smooth concentric rings called races. The inner race is typically attached to a rotating shaft or wheel, while the outer race is typically attached to a housing. As the wheel or shaft rotates, the bearings roll, allowing for smooth and efficient movement with minimal resistance. This design not only enhances the performance and longevity of the machinery but also ensures precision and stability in high-speed applications. Bearings are commonly used in automotive vehicles and powertrains, industrial machinery, wind mills and various other applications where reliable and efficient rotation is essential. However, some bearings are prone to white etching cracks that may lead to premature bearing failures. Such cracks initiate within the hard and brittle martensitic structure, with influence of inclusions/carbides/hydrogen embrittlement and may propagate quickly to the surface causing spalling and compromising the durability, which may lead to the failure of a ball bearing. Therefore, there is a need for improved heat treatment process for forming bearings.

Disclosed example steel bearings include a microstructure combination of a bainite core and a nitrogen-strengthened surface layer through a one-step carbo-nitro-austempering process. Compared to conventional through-hardened martensitic steel bearings, the new microstructures, while meeting both the surface and sub-surface stress requirements, minimize the content of pre-existing cracks from martensitic transformation and reduce the crack sensitivity to inclusions/carbides/hydrogen embrittlement due to improved material toughness and optimized residual stress distribution, which will help to prevent the formation of white etching cracks and eventually avoid pre-mature bearing failures.

While example steel bearings (e.g., a drive unit or transmission bearing) are shown and described herein in connection with a vehicle (e.g., an automobile, a truck, an airplane, a train, a motorcycle, etc.), it should be understood that disclosed steel bearings may additionally, or alternatively, be used with any other type(s) of device or machine.

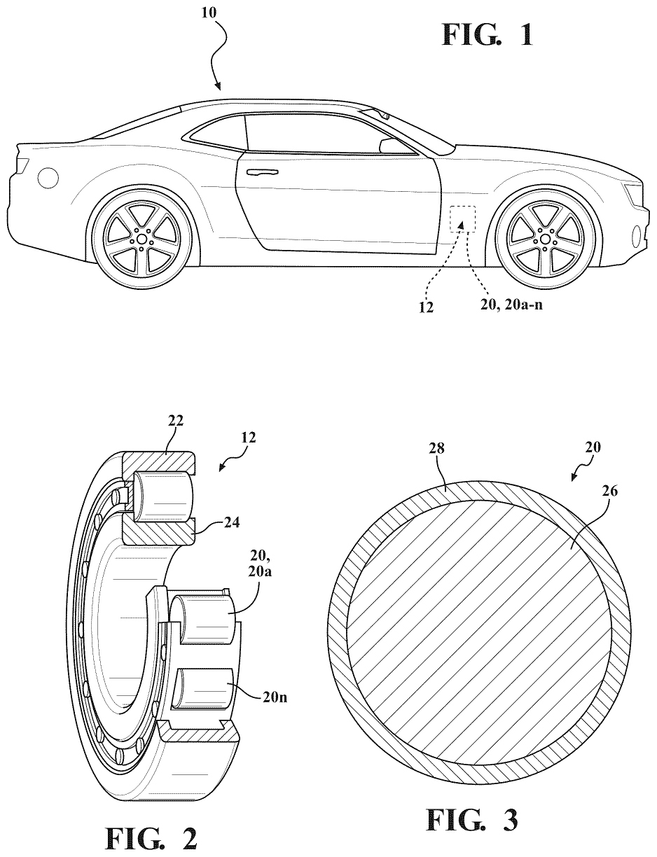

With particular reference to FIGS. 1, 2, and 3, a vehicle 10 (e.g., an automobile, a truck, an airplane, a train, a motorcycle, etc.) is shown in conjunction with a steel bearing 12 (e.g., a drive unit or transmission bearing 12) that includes a plurality of rolling elements 20, 20a-n in accordance with the principles of the present disclosure. In the illustrated example, the bearing rolling elements 20 are cylindrical roller elements. However, the rolling elements 20 may have any other shape including, but not limited to, spherical balls, and needle rollers. The rolling elements 20 are positioned between an outer bearing race 22 and an inner bearing race 24. Here, the rolling elements 20 are configured to maintain a substantially fixed distance between the outer bearing race 22 and the inner bearing race 24, and to reduce a rotational friction between the outer bearing race 22 and the inner bearing race 24 as the outer bearing race 22 and the inner bearing race 24 rotate with respect to each other.

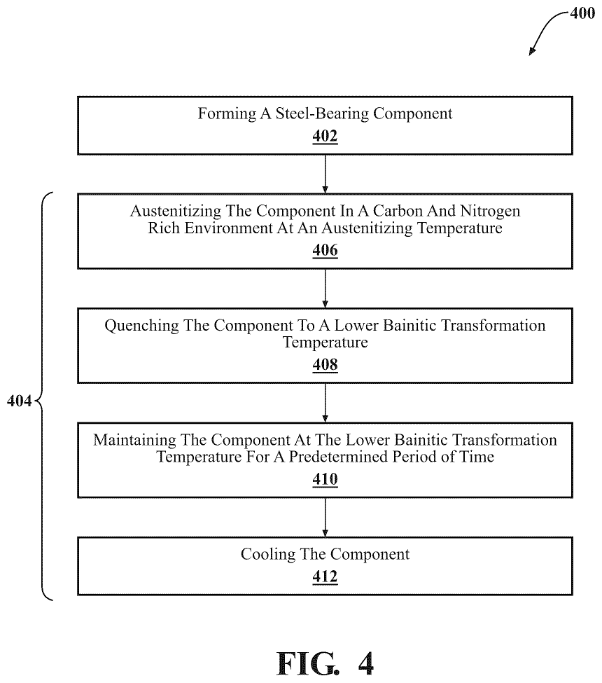

In the illustrated example, at least one of, or each of, the bearings 20, the outer bearing race 22, or the inner bearing race 24 are formed to include a bainite-dominant core 26 and a nitrogen-strengthened surface layer 28 (see FIG. 3). While FIG. 3 shows a circular cross-section of a rolling element 20, it should be understood that the outer bearing race 22 and/or the inner bearing race 24 could be formed to have any cross-sectional shape that also includes an inner core 26 and a nitrogen-strengthened surface layer 28. Here, the nitrogen-strengthened surface layer 28 is formed by diffusing nitrogen and carbon into a surface layer of the bainite-dominant core 26 using a single carbo-nitro-austempering heat treatment cycle (see FIG. 4). Alternatively, only nitrogen is diffused into the surface layer of the bainite-dominant core 26. In some examples, the amount of carbon diffused into the surface layer of the bainite-dominant core 26 is selected based on the amount of carbon in the bainite-dominant core 26 and/or to prevent decarbonization of the surface layer of the bainite-dominant core 26. In some implementations, the nitrogen-strengthened surface layer 28 has a thickness of at least 50 microns (e.g., a thickness between 50 and 1000 microns), a surface hardness of at least 75 HR30N, and a surface roughness of less than 0.04 microns. In some examples, the nitrogen-strengthened surface layer 28 includes at least 15 percent retained austenite to improve the resistance to debris indentation with self-healing capability while maintaining sufficient surface hardness.

In some implementations, the bainite-dominant core 26 contains at least 80 percent bainite, between 0 and 10 percent retained austenite, and between 0 and 10 percent carbides with tempered martensite remainder to yield sufficient material strength for sub-surface shear stress with enhancing the material to reduce crack sensitivity. In some examples, the bainite-dominant core 26 has a hardness of at least 25 HRC.

FIG. 4 is a flowchart of an exemplary arrangement of operations for a method 400 for forming a component (e.g., a rolling element 20, an outer race 22 and/or an inner race 24) for a steel bearing 12 in accordance with the principles of the disclosure. The operations may be controlled by, for example, data processing hardware (e.g., a processor) of a process controller based on executing instructions stored on memory hardware (e.g., memory). Many other ways of implementing the method 400 may be employed. For example, the order of execution of the operations may be changed, and/or one or more of the operations and/or interactions may be changed, eliminated, sub-divided, or combined.

At operation 402, the method 400 includes forming a steel-bearing component of a bainite-dominant material, for example, having a bainite-dominant core 26. The component may be formed of low carbon steel (e.g., SAE 5120) or high carbon steel (e.g., SAE 52100) with or without additional alloying elements.

At operation 404, the method 400 includes forming a nitrogen-strengthened surface layer 28 on the component by diffusing nitrogen with or without carbon into a surface layer of the component using a one-step carbo-nitro-austempering heat treatment cycle. In particular, at operation 406, the one-step carbon nitrogen austempering heat treatment cycle includes austenitizing the component in a carbon and nitrogen rich environment at an austenitizing temperature that is, for example, above the martensitic transformation start temperature (e.g., between 800° C. and 1000° C.). At operation 408, the one-step carbo-nitro-austempering heat treatment cycle includes quenching the component to a lower bainitic transformation temperature (e.g., between 180° C. and 300° C.) that is above the martensitic transformation start temperature using, for example, a salt bath or isothermal media. At operation 410, the one-step carbo-nitro-austempering heat treatment cycle includes maintaining the component at the lower bainitic transformation temperature for a pre-determined period of time (e.g., between one and thirty hours). At operation 412, the one-step carbo-nitro-austempering heat treatment cycle includes cooling the component. In some implementations, the cooled component is machined (e.g., grinding, honing and/or burnishing) to reduce a surface roughness of the rolling elements 20, outer race 22, and inner race 24 (e.g., to a surface roughness Ra of less than or equal to 0.04 microns).

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising a steel bearing comprising:
an inner bearing race;
an outer bearing race; and
a plurality of rolling elements positioned between the inner bearing race and the outer bearing race to maintain a substantially fixed distance between the inner bearing race and the outer bearing race and to reduce a rotational friction between the inner bearing race and the outer bearing race as the inner bearing race and the outer bearing race rotate with respect to each other, wherein at least one of the inner bearing race, the outer bearing race, or the rolling elements comprise:
a bainite-dominant core; and
a nitrogen-strengthened surface layer, wherein the nitrogen-strengthened surface layer is formed by diffusing nitrogen with or without carbon into a surface layer of the at least one of the inner bearing race, the outer bearing race, or the rolling elements using a one-step carbo-nitro-austempering heat treatment cycle.

2. The vehicle of claim 1, wherein the nitrogen-strengthened surface layer is formed by also diffusing carbon into the surface layer.

3. The vehicle of claim 1, wherein the one-step carbo-nitro-austempering heat treatment cycle comprises:
austenitizing a steel-bearing component in a carbon and nitrogen rich environment at an austenitizing temperature;
quenching the component to a lower bainitic transformation temperature that is above a martensitic transformation start temperature;
maintaining the component at the lower bainitic transformation temperature for a pre-determined period of time; and
cooling the component.

4. The vehicle of claim 3, wherein the steel-bearing component comprises high carbon steel or low carbon steel with or without additional alloying elements.

5. The vehicle of claim 3, wherein:
the austenitizing temperature is between 800° C. and 1000° C.;
quenching the component comprises using a salt bath or isothermal media to quench the component;
the lower bainitic transformation temperature is between 180° C. and 300° C.; and
the pre-determined period of time comprises a period of time between one and thirty hours.

6. The vehicle of claim 1, wherein the nitrogen-strengthened surface layer comprises:
a thickness between 50 and 1000 microns; and
a surface hardness of at least 75 HR30N.

7. The vehicle of claim 1, wherein the nitrogen-strengthened surface layer comprises a thickness of at least 50 microns.

8. The vehicle of claim 1, wherein the nitrogen-strengthened surface layer comprises at least 15 percent retained austenite.

9. The vehicle of claim 1, wherein the bainite-dominant core comprises:
at least 80 percent bainite;
between 0 and 10 percent retained austenite; and
between 0 and 10 percent carbides with tempered martensite remainder.

10. The vehicle of claim 1, wherein the bainite-dominant core comprises a hardness of at least 25 HRC.

11. A method for forming a component for a steel bearing, the method comprising:
forming a steel-bearing component comprising a bainite-dominant material; and
forming in the steel-bearing component a nitrogen-strengthened surface layer,
wherein the nitrogen-strengthened surface layer is formed by diffusing nitrogen with or without carbon into a surface layer of the component using a one-step carbo-nitro-austempering heat treatment cycle.

12. The method of claim 11, wherein the one-step carbo-nitro-austempering heat treatment cycle comprises:
austenitizing the steel-bearing component in a carbon and nitrogen rich environment at an austenitizing temperature;
quenching the component to a lower bainitic transformation temperature that is above a martensitic transformation start temperature;
maintaining the component at the lower bainitic transformation temperature for a pre-determined period of time; and
cooling the component.

13. The method of claim 12, wherein the steel-bearing component comprises high carbon steel or low carbon steel with or without additional alloying elements.

14. The method of claim 12, wherein:
the austenitizing temperature is between 800° C. and 1000° C.;
quenching the component comprises using a salt bath or isothermal media to quench the component;
the lower bainitic transformation temperature is between 180° C. and 300° C.; and
the pre-determined period of time comprises a period of time between one and thirty hours.

15. A component for a steel bearing, the component comprising:
a bainite-dominant core; and
a nitrogen-strengthened surface layer, wherein the nitrogen-strengthened surface layer is formed by diffusing nitrogen with or without carbon into a surface layer of the component using a one-step carbo-nitro-austempering heat treatment cycle.

16. The bearing of claim 15, wherein the nitrogen-strengthened surface layer comprises:
a thickness between 50 and 1000 microns; and
a surface hardness of at least 75 HR30N.

17. The bearing of claim 15, wherein the nitrogen-strengthened surface layer comprises a thickness of at least 50 microns.

18. The bearing of claim 16, wherein the nitrogen-strengthened surface layer comprises at least 15 percent retained austenite.

19. The bearing of claim 16, wherein the bainite-dominant core comprises:
at least 80 percent bainite;
between 0 and 10 percent retained austenite; and
between 0 and 10 percent carbides with tempered martensite remainder.

20. The bearing of claim 16, wherein the bainite-dominant core comprises a hardness of at least 25 HRC.
